(19) United States
(12) Patent Application Publication
(10) Pub. No.: US 2026/0275076 A1
(43) Pub. Date: Sep. 17, 2026

(54) DIENE RUBBER COMPOSITION COMPRISING A POLYNITRONE

(71) Applicant: Compagnie Generale Des Etablissements Michelin, Clermont-Ferrand (FR)

(72) Inventors: François JEAN-BAPTISTE-DIT-DOMINIQUE, Clermont-Ferrand (FR); Kahina MAMMERI, Clermont-Ferrand (FR); Sergey IVANOV, Clermont-Ferrand (FR); Ruslan NASYBULLIN, Clermont-Ferrand (FR)

(73) Assignee: Compagnie Generale Des Etablissements Michelin, Clermont-Ferrand (FR)

(21) Appl. No.: 18/876,335

(22) PCT Filed: Jun. 8, 2023
(86) PCT No.: PCT/EP2023/065354

§ 371 Date: Dec. 18, 2024

(30) Foreign Application Priority Data
Jun. 20, 2022 (FR) 2206004

(51) Int. Cl. C08K 5/33; B60C 1/00; C08F 236/10; C08K 3/04; C08K 5/45

(52) U.S. Cl. CPC C08K 5/33; B60C 1/00; C08F 236/10; C08K 3/04; C08K 5/45

(57) ABSTRACT

A rubber composition comprising a diene elastomer, a reinforcing filler and a compound which is of formula (I) or (II):

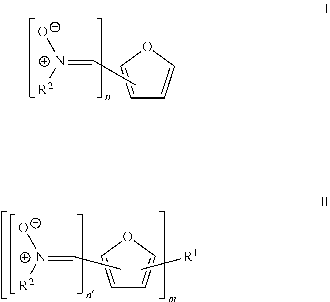

in which:
n is an integer ranging from 2 to 4,
n′ is an integer ranging from 1 to 3,
m is an integer greater than or equal to 2,
R¹ is a group of valency m connecting the furan aromatic rings of the compound of formula (II), and
R² is a hydrocarbon group which can be interrupted by one or more heteroatoms, is provided.

### CROSS REFERENCE TO RELATED APPLICATIONS

This U.S. patent application is a national phase entry of PCT Patent Application No. PCT/EP2023/065354, filed Jun. 8, 2023, which claims priority to French Patent Application No. FR 2206004, filed Jun. 20, 2022, the entire contents of which are incorporated herein by reference in their entirety.

### BACKGROUND

### 1. Technical Field

The field of the present invention is that of diene rubber compositions reinforced by a filler which can be used in particular in the manufacture of tires for vehicles.

### 2. Related Art

It is known to crosslink the diene elastomers in a rubber composition to give the rubber composition the properties of elasticity, of stiffness and of reinforcement which are desired according to the application envisaged. It has been customary for a great many years to resort to vulcanization in diene rubber compositions for tires.

It has also been proposed to use, in diene rubber compositions for tires, crosslinking agents other than sulfur, such as polynitrones. For example, the document JP 2007070439 teaches the addition, to a diene rubber composition reinforced with a carbon black, of an aromatic dinitrone, the compound diphenyl-p-phenylene dinitrone or the compound dimethyl-p-phenylene dinitrone, in order to improve the curing and fatigue properties of the rubber composition. The document JP 2015098591 also describes the addition of aromatic dinitrones, such as the compound N,N′-[benzene-1,4-diyldimethylylidene]bis(N-phenylamine oxide), to a diene rubber composition reinforced with a silica, in order to improve its properties at break. The document WO 2015052131 A1 proposes replacing a vulcanization system conventionally used in a rubber composition and which is relatively complex with the multitude of its components, which are sulfur, primary or secondary accelerators, and vulcanization activators, with a single compound, a dinitrone, such as the compound N,N′-[benzene-1,3-diyldimethylylidene]bis(N-phenylamine oxide).

### SUMMARY

The Applicant Company has discovered that the use of a particular family of aromatic polynitrones in a diene rubber composition reinforced with a filler makes it possible to further improve the compromise in its properties which are the mechanical properties, in particular tensile properties, and the dynamic properties. The polynitrones of use for the requirements of the invention contain at least two carbon atoms each a constituent of a separate nitrone dipole and which are each involved in a covalent bond with a carbon atom of a furan aromatic ring, which is or is not separate.

Thus, a first subject-matter of the invention is a rubber composition comprising a diene elastomer, a reinforcing filler and a compound which is of formula (I) or (II):

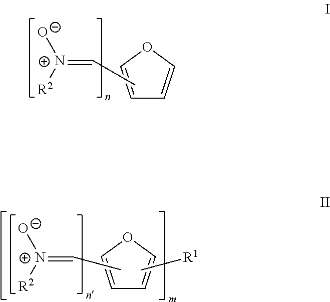

in which:
n is an integer ranging from 2 to 4,
n′ is an integer ranging from 1 to 3,
m is an integer greater than or equal to 2,
R¹ is a group of valency m connecting the furan aromatic rings of the compound of formula (II),
R² is a hydrocarbon group which can be interrupted by one or more heteroatoms.

Another subject-matter of the invention is a tire which contains a rubber composition in accordance with the invention.

### DETAILED DESCRIPTION OF EXAMPLE EMBODIMENTS

Any interval of values denoted by the expression “between a and b” represents the range of values greater than “a” and less than “b” (that is to say, limits a and b excluded), whereas any interval of values denoted by the expression “from a to b” means the range of values extending from “a” up to “b” (that is to say, including the strict limits a and b).

The abbreviation “phr” means parts by weight per hundred parts of elastomer (of the total of the elastomers, if several elastomers are present).

The compounds mentioned in the description can be of fossil origin or can be biobased. In the latter case, they can result, partially or completely, from biomass or be obtained, partially or completely, from renewable starting materials resulting from biomass. In the same way, the compounds mentioned can also originate from the recycling of pre-used materials, that is to say that they can, partially or completely, result from a recycling process, or else be obtained, partially or completely, from starting materials which themselves result from a recycling process.

The term “diene elastomer” should be understood as meaning an elastomer comprising diene monomer units, especially conjugated diene, in particular 1,3-diene, monomer units. The term “diene monomer unit” is understood to mean any unit which results from the insertion of a diene into a polymer chain and which contains a carbon-carbon double bond.

In the present invention, the term “tire” is understood to mean a pneumatic or non-pneumatic tire. A pneumatic tire usually comprises two beads intended to come into contact with a rim, a crown composed of at least one crown reinforcement and a tread, and two sidewalls, the tire being reinforced by a carcass reinforcement anchored in the two beads. A non-pneumatic tire, for its part, usually comprises a base, designed for example for mounting on a rigid rim, a crown reinforcement, ensuring the connection with a tread, and a deformable structure, such as spokes, ribs or cells, this structure being arranged between the base and the crown. Such non-pneumatic tires do not necessarily comprise a sidewall. Non-pneumatic tires are described, for example, in the documents WO 03/018332 and FR 2 898 077. According to any one of the embodiments of the invention, the tire according to the invention is preferentially a pneumatic tire.

The diene elastomer of use for the requirements of the invention can be:
(a)—any homopolymer of a conjugated or non-conjugated diene monomer having from 4 to 24 carbon atoms;
(b)—any copolymer of a conjugated or non-conjugated diene having from 4 to 24 carbon atoms and of at least one other monomer.

The term “copolymer of a conjugated or non-conjugated diene having from 4 to 24 carbon atoms and of at least one other monomer” should be understood as meaning a copolymer of a diene and of one or more other monomer(s). Mention may be made, as other monomer, of ethylene, an olefin and a conjugated or non-conjugated diene other than the first diene.

Suitable as conjugated dienes are conjugated dienes having from 4 to 24 carbon atoms, in particular 1,3-dienes having from 4 to 12 carbon atoms, such as in particular 1,3-butadiene and isoprene, or also a 1,3-diene of formula CH₂═CR—CH═CH₂, in which R represents a hydrocarbon chain having from 3 to 20 carbon atoms, such as, for example, a linear monoterpene (C₁₀H₁₆), such as myrcene, a linear sesquiterpene (C₁₅H₂₄), such as farnesene, and the like. Very particularly, suitable as conjugated dienes are 1,3-butadiene, isoprene, myrcene and farnesene.

Suitable as non-conjugated dienes are non-conjugated dienes having from 6 to 12 carbon atoms, such as 1,4-hexadiene, ethylidenenorbornene or dicyclopentadiene.

Suitable as olefins are vinylaromatic compounds having from 8 to 20 carbon atoms and aliphatic α-monoolefins having from 3 to 12 carbon atoms.

Suitable as vinylaromatic compounds are, for example, styrene, ortho-, meta- or para-methylstyrene, the “vinyltoluene” commercial mixture or para-(tert-butyl) styrene.

Suitable as aliphatic a-monoolefins are in particular acyclic aliphatic α-monoolefins having from 3 to 18 carbon atoms.

More particularly, the diene elastomer is:
(a′)—any homopolymer of a conjugated diene monomer, in particular any homopolymer obtained by polymerization of a conjugated diene monomer having from 4 to 12 carbon atoms;
(b′)—any copolymer obtained by copolymerization of one or more conjugated dienes with one another or with one or more vinylaromatic compounds having from 8 to 20 carbon atoms;
(c′)—any copolymer obtained by copolymerization of ethylene with one or more conjugated dienes.

Preferably, the diene elastomer is selected from the group of elastomers consisting of 1,3-butadiene homopolymers, isoprene homopolymers, 1,3-butadiene copolymers, isoprene copolymers and their mixtures.

Another characteristic of the rubber composition in accordance with the invention is that of containing a reinforcing filler. The total content of reinforcing filler in the rubber composition is preferably greater than or equal to 20 phr and less than or equal to 200 phr, very preferentially greater than or equal to 25 phr and less than or equal to 160 phr. It is adjusted by a person skilled in the art as a function of the use of the rubber composition.

The rubber composition can comprise any type of “reinforcing” filler known for its abilities to reinforce a rubber composition which can be used in particular for the preparation of tires, a carbon black, a reinforcing inorganic filler, such as silica, or also a mixture of these two types of fillers. The reinforcing filler preferentially comprises a carbon black, a silica or a mixture of a carbon black and of a silica.

Suitable as carbon blacks are all carbon blacks, in particular the blacks conventionally used in tires or their treads. Among the latter, mention will more particularly be made of the reinforcing carbon blacks of the 100, 200 and 300 series, or the blacks of the 500, 600 or 700 series (ASTM D-1765-2017 grades), such as, for example, the N115, N134, N234, N326, N330, N339, N347, N375, N550, N683 and N772 blacks. These carbon blacks can be used in the isolated state, as commercially available, or in any other form, for example as support for some of the rubber additives used. Use may be made, as a carbon black, of one carbon black or of a mixture of carbon blacks.

The term “reinforcing inorganic filler” should be understood, in the present patent application, as meaning, by definition, any inorganic or mineral filler, whatever its colour and its origin (natural or synthetic), also referred to as “white filler”, “clear filler”, indeed even “non-black filler”, in contrast to carbon black, capable of reinforcing, by itself alone, without means other than an intermediate coupling agent, a rubber composition intended for the manufacture of tires, in other words capable of replacing, in its reinforcing role, a conventional tire-grade carbon black; such a filler is generally characterized, in a known way, by the presence of hydroxyl (—OH) groups at its surface.

Mineral fillers of the siliceous type, preferentially silica (SiO₂), are suitable in particular as reinforcing inorganic fillers. The silica used can be any reinforcing silica known to a person skilled in the art, in particular any precipitated or fumed silica exhibiting a BET specific surface and also a CTAB specific surface both of less than 450 m²/g, preferably from 30 to 400 m²/g, in particular from 60 to 300 m²/g. Use may be made of any type of precipitated silica, in particular highly dispersible precipitated silicas (HDSs). These precipitated silicas, which are or are not highly dispersible, are well known to a person skilled in the art. Mention may be made, for example, of the silicas described in Applications WO 03/016215-A1 and WO 03/016387-A1. In the present account, the BET specific surface is determined in a known way by gas adsorption using the Brunauer-Emmett-Teller method described in The Journal of the American Chemical Society, Vol. 60, page 309, February 1938, more specifically according to French Standard NF ISO 9277 of December 1996 (multipoint (5 point) volumetric method-gas: nitrogen-degassing: 1 hour at 160° C. —relative pressure p/po range: 0.05 to 0.17). The CTAB specific surface is the external surface area determined according to French Standard NF T 45-007 of November 1987 (method B).

In order to couple the silica to the diene elastomer, use may be made, in a well-known way, of an at least bifunctional coupling agent (or bonding agent) intended to provide a satisfactory connection, of chemical and/or physical nature, between the silica (surface of its particles) and the elastomer. Use is made in particular of organosilanes or polyorganosiloxanes which are at least bifunctional. Preferentially, the organosilanes are selected from the group consisting of organosilane polysulfides (symmetrical or asymmetrical), such as bis(3-triethoxysilylpropyl) tetrasulfide, abbreviated to TESPT, sold under the name Si69 by Evonik.

The rubber composition has also as another essential characteristic that of containing a polynitrone, a compound of formula (I) or (II), preferably of formula (I):

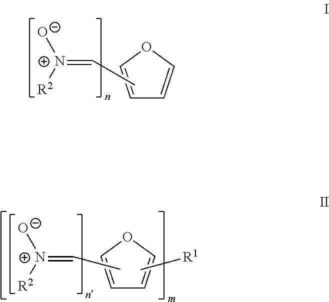

in which:
n is an integer ranging from 2 to 4,
n′ is an integer ranging from 1 to 3,
m is an integer greater than or equal to 2,
R¹ is a group of valency m connecting the furan aromatic rings of the compound of formula (II),
R² is a hydrocarbon group which can be interrupted by one or more heteroatoms.

Preferably, R¹ is a hydrocarbon group which can be interrupted by one or more heteroatoms, such as oxygen, sulfur, silicon or nitrogen.

R¹ can be an aliphatic group containing from 1 to 25 carbon atoms or an aromatic group containing from 6 to 25 carbon atoms. Preferably, R¹ is a saturated aliphatic group. When R¹ is a saturated aliphatic group, it can be linear, cyclic or branched. According to a first alternative form, R¹ is an alkanediyl group of formula —C_{y}H_{2y}—, y being an integer ranging from 1 to 6, preferentially from 1 to 3. According to a second alternative form, R¹ is an alkanediyl group interrupted with one or more oxygen atoms of formula —(CₓH₂ₓ—O)ₚ—CₓH₂ₓ—, x being an integer ranging from 1 to 6, preferentially from 1 to 3, and p being an integer greater than or equal to 1, preferentially equal to 1 or to 2.

R² can be an aliphatic group containing from 1 to 25 carbon atoms or an aromatic group containing from 6 to 25 carbon atoms. Preferably, R² is chosen from alkyl groups which are linear, branched or cyclic, aralkyl groups, alkylaryl groups and aryl groups.

In the formula (I), n is preferentially equal to 2. In the formula (II), m is preferentially equal to 2 and n′ is equal to 1. According to a first alternative form, m is equal to 2 and R¹ is an alkanediyl group of formula —C_{y}H_{2y}—, y being an integer ranging from 1 to 6, preferentially from 1 to 3. According to a second alternative form, m is equal to 2 and R¹ is an alkanediyl group interrupted with one or more oxygen atoms of formula —(CₓH₂ₓ—O)ₚ—CₓH₂ₓ—, x being an integer ranging from 1 to 6, preferentially from 1 to 3, and p being an integer greater than or equal to 1, preferentially equal to 1 or to 2, more preferentially equal to 1.

Very particularly suitable as compounds of formula (I) are the compounds for which n is equal to 2 and R² is methyl or phenyl, more particularly the compound N,N′-[2,5-furandiyldimethylidyne]bis(N-phenylamine oxide) of formula (III).

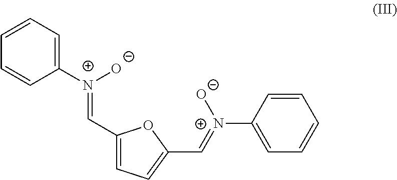 [SMILES: [O-]/[N+](=C\c1ccc(/C=[N+](\[O-])c2ccccc2)o1)c1ccccc1]

Very particularly suitable as compounds of formula (II) are the compounds for which m is equal to 2, n′ is equal to 1, R² is methyl or phenyl and R¹ is an alkanediyl group of formula —C_{y}H_{2y}—, y being an integer ranging from 1 to 3, or a group of formula —(CₓH₂ₓ—O)ₚ—CₓH₂ₓ—, x being an integer ranging from 1 to 3 and p being equal to 1, more particularly the compound N,N′-[oxybis(methylene-5,2-furandiylmethylidyne)]bis(N-phenylamine oxide)] of formula (IV).

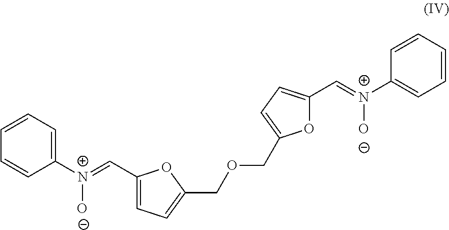 [SMILES: [O-]/[N+](=C\c1ccc(COCc2ccc(/C=[N+](\[O-])c3ccccc3)o2)o1)c1ccccc1]

According to any one of the embodiments of the invention, the polynitrone is advantageously of formula (III).

Polynitrones can be synthesized according to the well-known synthesis methods for synthesizing nitrones which result from the addition of a reactant which is a hydroxylamine to a substrate which is an aldehyde. In the case of the synthesis of a polynitrone of use for the requirements of the invention, the reactant is a hydroxylamine substituted by the R² group and the substrate is a compound which contains at least two aldehyde functions covalently bonded to a carbon atom of a furan aromatic ring.

The polynitrone compound of formula (I) or (II) is of use for the requirements of the invention as crosslinking agent and composes the crosslinking system of the rubber composition. According to the invention, the rubber composition comprises a crosslinking agent which is a compound of formula (I) or a mixture of compounds of formula (I), a compound of formula (II) or a mixture of compounds of formula (II) or else the mixture of at least one compound of formula (I) and of at least one compound of formula (II). The molar content of compound of formula (I) or (II) in the rubber composition, whether it is a single polynitrone compound of use for the requirements of the invention or a mixture of polynitrones, is adjusted by a person skilled in the art according to the level of stiffness required by the envisaged application of the rubber composition. It is preferentially from 0.01 mol % to 10 mol %, more preferentially from 0.05 mol % to 2 mol %, of constituent unit of the diene elastomer.

The rubber composition can additionally comprise, in its crosslinking system, sulfur, in the form of molecular sulfur or of a sulfur donor, a vulcanization accelerator and a vulcanization activator. The molecular sulfur (Ss), the sulfur donors, the vulcanization accelerators and the vulcanization activators are compounds well known to a person skilled in the art of diene rubber compositions, as is described in the document “Compounding and Vulcanization” by R. Rajesh Babu et al., published in Advances in Elastomer I, Advanced Structured Materials, 11, published by Springer-Verlag Berlin Heidelberg, 2013, pages 83-135. They constitute the vulcanization systems conventionally used in diene rubber compositions, for example for tires.

The use of a polynitrone of formula (I) or (II) in a diene rubber composition reinforced with a filler has the advantage of being able to reduce the share of a vulcanization system in the crosslinking system of the rubber composition in accordance with the invention and even to dispense with the use of a vulcanization system in the rubber composition in accordance with the invention. As a vulcanization system generally contains at least three ingredients which are sulfur or the sulfur donor, the vulcanization accelerator and the vulcanization activator, the use of the polynitrone in the rubber composition makes it possible to thus simplify the formulation of a rubber composition by the simple replacement of the vulcanization system by a single compound, the polynitrone. According to any one of the embodiments of the invention, the rubber composition in accordance with the invention preferentially contains less than 1 phr of sulfur, whether it originates from a molecular source (Ss) or from a sulfur donor. Advantageously, according to any one of the embodiments of the invention, it is devoid of sulfur, whether it originates from a molecular source (S₈) or from a sulfur donor.

The rubber composition in accordance with the invention can also comprise all or part of the usual additives customarily used in elastomer compositions intended to constitute finished rubber articles, such as tires, such as, for example, plasticizers or extender oils, pigments, protective agents, such as anti-ozone waxes, chemical antiozonants or antioxidants, or anti-fatigue agents.

The rubber composition in accordance with the invention is manufactured in appropriate mixers, using two successive phases of preparation well known to a person skilled in the art: a first phase of thermomechanical working or kneading (“non-productive” phase) at high temperature, up to a maximum temperature of between 130° C. and 200° C., followed by a second phase of mechanical working (“productive” phase) up to a lower temperature, typically below 110° C., for example between 40° C. and 100° C., during which finishing phase the crosslinking system is incorporated.

The rubber composition can be calendered or extruded in the form of a sheet or of a plaque, in particular for laboratory characterization, or also in the form of a rubber semi-finished product (or profiled element) which can be used in a tire. The composition can be either in the raw state (before crosslinking) or in the cured state (after crosslinking) and can constitute all or part of a semi-finished article, in particular intended to be used in a pneumatic or non-pneumatic tire. The crosslinking is carried out at a temperature generally of between 100° C. and 200° C., preferentially between 120° C. and 180° C., for a sufficient time which can vary, for example, between 5 and 90 minutes, as a function in particular of the curing temperature of the composition under consideration.

To sum up, the invention is advantageously implemented according to any one of the following Embodiments 1 to 20:

Embodiment 1: Rubber composition comprising a diene elastomer, a reinforcing filler and a compound which is of formula (I) or (II):

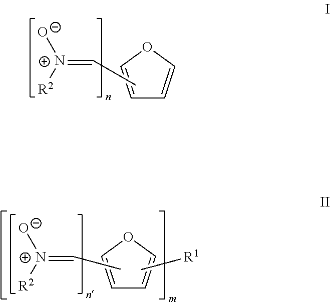

in which:
n is an integer ranging from 2 to 4,
n′ is an integer ranging from 1 to 3,
m is an integer greater than or equal to 2,
R¹ is a group of valency m connecting the furan aromatic rings of the compound of formula (II),
R² is a hydrocarbon group which can be interrupted by one or more heteroatoms.

Embodiment 2: Rubber composition according to Embodiment 1, in which R¹ is a hydrocarbon group which can be interrupted by one or more heteroatoms.

Embodiment 3: Rubber composition according to Embodiment 1 or 2, in which R¹ is a saturated aliphatic group.

Embodiment 4: Rubber composition according to any one of Embodiments 1 to 3, in which R¹ is an alkanediyl group of formula —C_{y}H_{2y}—, y being an integer ranging from 1 to 6, or an alkanediyl group interrupted with one or more oxygen atoms of formula —(CₓH₂ₓ—O)ₚ—CₓH₂ₓ—, x being an integer ranging from 1 to 6 and p being an integer greater than or equal to 1.

Embodiment 5: Rubber composition according to Embodiment 4, in which y ranges from 1 to 3.

Embodiment 6: Rubber composition according to Embodiment 4 or 5, in which x ranges from 1 to 3.

Embodiment 7: Rubber composition according to any one of Embodiments 4 to 6, in which p is equal to 1 or to 2.

Embodiment 8: Rubber composition according to any one of Embodiments 1 to 7, in which R² is chosen from alkyl groups which are linear, branched or cyclic, aralkyl groups, alkylaryl groups and aryl groups.

Embodiment 9: Rubber composition according to any one of Embodiments 1 to 8, in which n is equal to 2 in the formula (I).

Embodiment 10: Rubber composition according to any one of Embodiments 1 to 9, in which n is equal to 2 and R² is methyl or phenyl in the formula (I).

Embodiment 11: Rubber composition according to any one of Embodiments 1 to 10, in which the compound of formula (I) is the compound N,N′-[2,5-furandiyldimethylidyne]bis(N-phenylamine oxide) of formula (III):

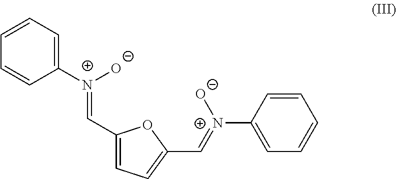 [SMILES: [O-]/[N+](=C\c1ccc(/C=[N+](\[O-])c2ccccc2)o1)c1ccccc1]

Embodiment 12: Rubber composition according to any one of Embodiments 1 to 11, in which, in the formula (II), m is equal to 2 and n′ is equal to 1.

Embodiment 13: Rubber composition according to any one of Embodiments 1 to 12, in which m is equal to 2, n′ is equal to 1, R² in the formula (II) is methyl or phenyl and R¹ is an alkanediyl group of formula —C_{y}H_{2y}—, y being an integer ranging from 1 to 3, or a group of formula —(CₓH₂ₓ—O)ₚ—CₓH₂ₓ—, x being an integer ranging from 1 to 3 and p being equal to 1.

Embodiment 14: Rubber composition according to any one of Embodiments 1 to 13, in which the compound of formula (II) is the compound N,N′-[oxybis(methylene-5,2-furandiylmethylidyne)]bis(N-phenylamine oxide)] of formula (IV):

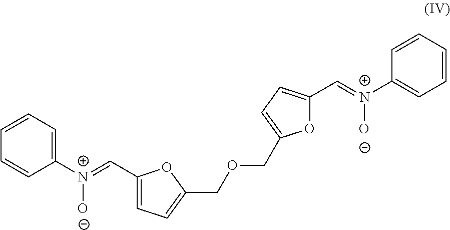 [SMILES: [O-]/[N+](=C\c1ccc(COCc2ccc(/C=[N+](\[O-])c3ccccc3)o2)o1)c1ccccc1]

Embodiment 15: Rubber composition according to any one of Embodiments 1 to 14, in which the molar content of compound of formula (I) or (II) is from 0.01 mol % to 10 mol % of constituent unit of the diene elastomer.

Embodiment 16: Rubber composition according to any one of Embodiments 1 to 15, in which the molar content of compound of formula (I) or (II) is from 0.05 mol % to 2 mol % of constituent unit of the diene elastomer.

Embodiment 17: Rubber composition according to any one of Embodiments 1 to 16, in which the reinforcing filler comprises a carbon black, a silica or a mixture of a carbon black and of a silica.

Embodiment 18: Rubber composition according to any one of Embodiments 1 to 17, in which the diene elastomer is selected from the group of elastomers consisting of 1,3-butadiene homopolymers, isoprene homopolymers, 1,3-butadiene copolymers, isoprene copolymers and their mixtures.

Embodiment 19: Rubber composition according to any one of Embodiments 1 to 18, in which the compound is of formula (I).

Embodiment 20: Tire which contains a rubber composition defined in any one of Embodiments 1 to 19.

A better understanding of the abovementioned characteristics of the present invention, and also of others, will be obtained on reading the following description of several implementational examples of the invention, which are given by way of illustration and without limitation.

### Examples

### Dynamic Properties:

The dynamic properties tan δ(max) are measured on a viscosity analyser (Metravib VA4000) according to Standard ASTM D 5992-96. The response of a sample of vulcanized composition (cylindrical test specimen with a thickness of 4 mm and with a cross section of 400 mm²), subjected to a simple alternating sinusoidal shear stress, at a frequency of 10 Hz, at 60° C., is recorded. A strain amplitude sweep is carried out from 0.1% to 100% (outward cycle) and then from 100% to 0.1% (return cycle). The results made use of are the loss factor tan δ and the shear modulus, denoted G*, between the values at 0.1% and 100% strain. For the return cycle, the maximum value of tan δ observed, denoted tan δ max, and the difference in the shear modulus, denoted ΔG*, are shown. The results are expressed in base 100. In the case of tan δ max, a result of less than 100 will indicate a decrease in the value concerned, that is to say a decrease in the hysteresis, and, conversely, a result of greater than 100 will indicate an increase in the value concerned. In the case of ΔG*, a result of less than 100 will indicate a decrease in the value concerned, that is to say a decrease in non-linearity (Payne effect), and, conversely, a result of greater than 100 will indicate an increase in the value concerned.

### Tensile Tests:

The tensile tests make it possible to determine the elasticity stresses and the properties at break. Unless otherwise indicated, they are carried out in accordance with French Standard NF T 46-002 of September 1988, with a test specimen of H2 type, the pull rate being 500 mm/min. Processing the tensile recordings also makes it possible to plot the curve of modulus as a function of the elongation, the modulus used here being the nominal (or apparent) secant modulus measured in first elongation, calculated by reducing to the initial cross section of the test specimen. The nominal secant moduli (or apparent stresses, in MPa) are measured in first elongation at 100% and 300% elongation, respectively denoted MSA100 and MSA300, at 23° C.±2° C. The breaking stresses (in MPa) and the elongations at break (in %) are also measured. The results are expressed in base 100. A value of greater than 100 indicates an improved result.

### Preparation of the Polynitrones:

Polynitrone 1: The compound N,N′-[benzene-1,4-diyldimethylylidene]bis(N-methylamine oxide) (CAS No. 63418-55-3) is prepared according to the procedure described in the document JP 2007070439.

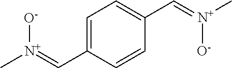

Polynitrone 2: The compound N,N′-[benzene-1,4-diyldimethylylidene]bis(N-phenylamine oxide) (CAS No. 1586-93-2) is prepared according to the procedure described in the document JP 2007070439.

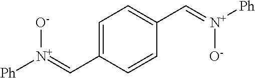 [SMILES: [O-]/[N+](=C\c1ccc(/C=[N+](\[O-])c2ccccc2)cc1)c1ccccc1]

Polynitrone 3: The compound N,N′-[benzene-1,3-diyldimethylylidene]bis(N-methylamine oxide) (CAS No. 1161001-51-9) is prepared according to the procedure described in the document WO 2009136920.

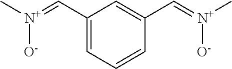

Polynitrone 4: The compound N,N′-[benzene-1,3-diyldimethylylidene]bis(N-phenylamine oxide) (CAS No. 15351-52-7) is prepared according to the procedure described in the document WO 2015052131.

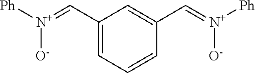 [SMILES: [O-]/[N+](=C\c1cccc(/C=[N+](\[O-])c2ccccc2)c1)c1ccccc1]

Polynitrone 5: The compound N,N′-[2,5-thiophenediyldimethylidyne]bis(N-phenylamine oxide) (CAS No. 1134370-29-8) is prepared according to the procedure described in the document US20090082580.

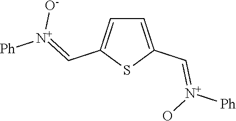 [SMILES: [O-]/[N+](=C\c1ccc(/C=[N+](\O)c2ccccc2)s1)c1ccccc1]

Polynitrone 6: The compound N,N′-[2,5-furandiyldimethylidyne]bis(N-phenylamine oxide) (CAS No. 1251471-39-2) is prepared according to the procedure described in the paper Journal of Molecular Structure (2010), 977(1-3), 175-179.

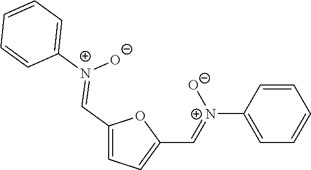 [SMILES: [O-]/[N+](=C\c1ccc(/C=[N+](\[O-])c2ccccc2)o1)c1ccccc1]

Polynitrone 7: Bisnitrone B (N,N′-[oxybis(methylene-5,2-furandiylmethylidyne)]bis(N-phenylamine oxide)) is prepared according to the following reaction scheme and the following procedure:

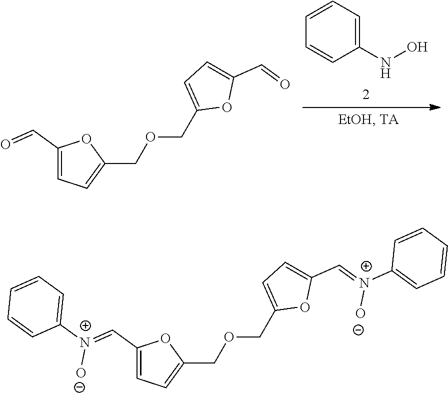

The compound 5,5′-(oxybis(methylene))bis(furan-2-carbaldehyde) is described in the literature and can be synthesized, for example, according to: Angew. Chem. Int. Ed., 2016, 55, 8338-8342, and Chem. Asian J., 2017, 12, 2652-2655.

In a second stage, N-phenylhydroxylamine (3.02 g; 27.7 mmol) is added to a suspension of 5,5′-(oxybis(methylene))bis(furan-2-carbaldehyde) (2.95 g; 12.6 mmol) in anhydrous ethanol (50 ml). The reaction mixture is subsequently stirred at 20° C. for 16-17 hours before being diluted with petroleum ether (40 ml). After 10-12 minutes under vigorous stirring at ambient temperature (AT), the precipitate obtained is filtered off, washed in series with methyl tert-butyl ether (2×10 ml) and petroleum ether (2×10 ml), and then dried.

A brown solid (3.928 g; 9.43 mmol) with a molar purity at 98% (NMR) is obtained with a yield of 75%.

The assignments of the signals in 1H and ¹³C NMR are listed in the following table:

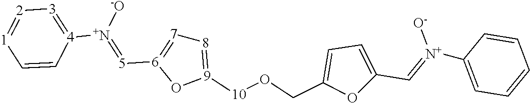

| No. | δ ¹H (ppm) | δ ¹³C (ppm) |
|---|---|---|
| 1 | ~7.49 | 129.9 |
| 2 | 7.87-7.90 | 120.8 |
| 3 | ~7.45 | 129.1 |
| 4 | / | 146.8 |
| 5 | 8.70 | 123.5 |
| 6 | / | 147.9 |
| 7 | 7.76 | 116.0 |
| 8 | 6.70 | 112.5 |
| 9 | / | 153.4 |
| 10 | 4.52 | 63.2 |

Solvent: d₆-DMSO
Calibration in ¹H at 2.44 ppm; calibration in ¹³C at 39.5 ppm.

### Preparation of the Rubber Compositions:

The procedure for the preparation of the compositions C0 and C1 to C7 is as follows: the diene elastomer, the reinforcing filler and then, after kneading for one to two minutes, the various other ingredients, with the exception of the crosslinking system (polynitrone compound) or of the vulcanization system (sulfur and sulfenamide accelerator), are introduced into an internal mixer which is 70% filled and which has an initial vessel temperature of approximately 90° C. Thermomechanical working is then carried out (non-productive phase) in one stage (total duration of the kneading equal to approximately 5 min), until a maximum “dropping” temperature of approximately 160° C. is reached. The mixture thus obtained is recovered and cooled and then the crosslinking system (polynitrone compound) or the vulcanization system (sulfur and sulfenamide accelerator) is added on an external mixer (homofinisher) at 70° C., everything being mixed (productive phase) for approximately 5 to 6 min.

The compositions C0 and C1 to C7 thus obtained are subsequently calendered, either in the form of plaques (thickness of 2 to 3 mm) or of thin sheets of rubber, for the measurement of their physical or mechanical properties, or in the form of profiled elements which can be used directly, after cutting and/or assembling to the desired dimensions, for example as semi-finished products for tires. The test specimens are subsequently placed under a press at a temperature between 170° C. and 180° C. for 30 min for the compositions C1 to C6 based on polynitrones or at a temperature of between 150° C. and 160° C. for the composition C0 comprising a vulcanization system.

The formulations of the rubber compositions C0 and C1 to C7 are described in Table 1; the proportions of the ingredients of the rubber compositions are expressed in phr. The content of polynitrone introduced into the compositions C1 to C7 corresponds to a molar content of 0.42%, with respect to the constituent unit of SBR.

The rubber composition C0 is a rubber composition which has, as crosslinking system, a vulcanization system conventionally used in rubber compositions for tires.

The rubber compositions C1 to C7 are all rubber compositions in which the crosslinking agent is a polynitrone. The rubber compositions C1 to C5 are rubber compositions not in accordance with the invention, since they contain a polynitrone, respectively the polynitrone 1 to 5, corresponding neither to the formula (I) nor to the formula (II). The rubber compositions C6 and C7 are rubber compositions in accordance with the invention, since they respectively contain a polynitrone of formula (I) and a polynitrone of formula (II).

The results appear in Table 2.

Among the rubber compositions which contain a polynitrone, the compositions C6 and C7 are the rubber compositions which have the lowest tan δ max values and exhibit the highest secant moduli at 100% and at 300%. The use of the composition C6 and of the composition C7 is accompanied by an improvement in the hysteresis and tensile properties, seen respectively through tan δ max and the secant moduli at 100% and at 300% at 23° C., with respect to the other polynitrones.

Moreover, it is observed that, compared with the use of polynitrone 5, the use of polynitrone 6 and of polynitrone 7 gives a rubber composition both a lower hysteresis and a lower non-linearity, even though polynitrone 6 differs from polynitrone 5 only in the nature of the aromatic ring, a furan ring in polynitrone 5 and a thiophene ring in polynitrone 6, and though polynitrone 7 contains two furan rings instead of one.

It is found that it is also the composition C6 which exhibits the properties at break closest to those of the composition C0, both at 23° C. and at 100° C. The replacement of the vulcanization system of the composition C0 by the crosslinking system of the composition C6, in the case in point polynitrone 6, virtually does not modify the tensile properties of the rubber composition, unlike the other polynitrones.

Crosslinking using a polynitrone which has the characteristic of containing at least two nitrone dipoles attached directly to a furan aromatic ring has the advantage of giving a rubber composition the lowest hysteresis, compared with crosslinking using a nitrone not exhibiting this characteristic. Moreover, this result is obtained without substantially modifying the hysteresis and tensile properties of a vulcanized rubber composition in the case of the use of a polynitrone of formula (I).

The replacement of the vulcanization system conventionally used in diene rubber compositions by a single compound, a polynitrone of use for the requirements of the invention, makes it possible clearly to simplify the formulation of diene rubber compositions.

TABLE 1

| Composition | C0 | C1 | C2 | C3 | C4 | C5 | C6 | C7 |
|---|---|---|---|---|---|---|---|---|
| SBR (1) | 100 | 100 | 100 | 100 | 100 | 100 | 100 | 100 |
| N234 (2) | 54 | 54 | 54 | 54 | 54 | 54 | 54 | 54 |
| Antioxidant (3) | 2 | 2 | 2 | 2 | 2 | 2 | 2 | 2 |
| ZnO (4) | 2 | | | | | | | |
| Stearic acid (5) | 2.70 | | | | | | | |
| Accelerator (6) | 1.50 | | | | | | | |
| Sulfur | 1.50 | | | | | | | |
| Polynitrone 1 | | 1.22 | | | | | | |
| Polynitrone 2 | | | 2.00 | | | | | |
| Polynitrone 3 | | | | 1.22 | | | | |
| Polynitrone 4 | | | | | 2.00 | | | |
| Polynitrone 5 | | | | | | 2.04 | | |
| Polynitrone 6 | | | | | | | 1.92 | |
| Polynitrone 7 | | | | | | | | 2.46 |

(1) Copolymer of 1,3-butadiene and of styrene (SBR) containing 26% by weight of styrene units and 24% by weight of 1,2-butadiene units, with respect to the butadiene part, with a glass transition temperature, Tg, of −48° C. measured by DSC (Differential Scanning Calorimetry) according to Standard ASTM D3418 (1999);
(2) Carbon black, N234;
(3) N-(1,3-Dimethylbutyl)-N′-phenyl-p-phenylenediamine, Santoflex 6PPD from Flexys;
(4) Zinc oxide (industrial grade - from Umicore);
(5) Stearin (Pristerene 4931 - Uniqema);
(6) CBS: N-Cyclohexyl-2-benzothiazolesulfenamide (Santocure CBS from Flexsys).

TABLE 2

| Composition | C0 | C1 | C2 | C3 | C4 | C5 | C6 | C7 |
|---|---|---|---|---|---|---|---|---|
| Strain measurement | | | | | | | | |
| at 23° C. | | | | | | | | |
| Elongation at break (%) | 93 | 88 | 147 | 140 | 130 | 141 | 100 | 117 |
| Breaking stress (MPa) | 100 | 15 | 36 | 32 | 74 | 48 | 100 | 69 |
| MSA100 | 94 | 47 | 47 | 50 | 62 | 62 | 100 | 75 |
| MSA300 | 106 | 21 | 27 | 27 | 55 | 38 | 100 | 57 |
| MSA300/MSA100 | 113 | 43 | 56 | 52 | 89 | 61 | 100 | 76 |
| Strain measurement | | | | | | | | |
| at 100° C. | | | | | | | | |
| Elongation at break (%) | 105 | 85 | 163 | 161 | 153 | 163 | 100 | 120 |
| Breaking stress (MPa) | 106 | 14 | 43 | 38 | 91 | 58 | 100 | 67 |
| Dynamic properties | | | | | | | | |
| at 60° C. | | | | | | | | |
| tanδ max | 96 | 120 | 127 | 126 | 117 | 135 | 100 | 108 |
| ΔG* | 143 | 59 | 97 | 91 | 81 | 120 | 100 | 92 |

What is claimed is:

1. A rubber composition comprising a diene elastomer, a reinforcing filler and a compound which is of formula (I) or (II): 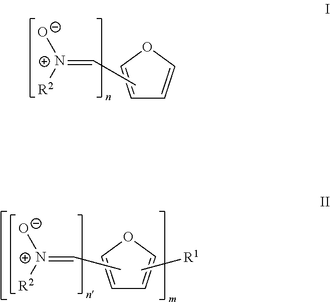
in which:
n is an integer ranging from 2 to 4,
n′ is an integer ranging from 1 to 3,
m is an integer greater than or equal to 2,
R¹ is a group of valency m connecting the furan aromatic rings of the compound of formula (II),
R² is a hydrocarbon group which can be interrupted by one or more heteroatoms.

2. The rubber composition according to claim 1, in which R¹ is a hydrocarbon group which can be interrupted by one or more heteroatoms.

3. The rubber composition according to claim 1, in which R¹ is a saturated aliphatic group.

4. The rubber composition according to claim 1, in which R¹ is an alkanediyl group of formula —C_{y}H_{2y}—, y being an integer ranging from 1 to 6, or an alkanediyl group interrupted with one or more oxygen atoms of formula —(CₓH₂ₓ—O)ₚ—CₓH₂ₓ—, x being an integer ranging from 1 to 6, preferentially from 1 to 3, and p being an integer greater than or equal to 1, preferentially equal to 1 or to 2.

5. The rubber composition according to claim 1, in which R² is chosen from alkyl groups which are linear, branched or cyclic, aralkyl groups, alkylaryl groups and aryl groups.

6. The rubber composition according to claim 1, in which n is equal to 2.

7. The rubber composition according to claim 1, in which m is equal to 2 and n′ is equal to 1.

8. The rubber composition according to claim 1, in which the molar content of compound of formula (I) or (II) is from 0.01 mol % to 10 mol % of constituent unit of the diene elastomer.

9. The rubber composition according to claim 1, in which the reinforcing filler comprises a carbon black, a silica or a mixture of a carbon black and of a silica.

10. The rubber composition according to claim 1, in which the diene elastomer is selected from the group of elastomers consisting of 1,3-butadiene homopolymers, isoprene homopolymers, 1,3-butadiene copolymers, isoprene copolymers and their mixtures.

11. The rubber composition according to claim 1, in which the compound is of formula (I).

12. A tire which contains a rubber composition defined in claim 1.

13. The rubber composition according to claim 4, wherein y is an integer ranging from 1 to 3.

14. The rubber composition according to claim 4, wherein x is an integer ranging from 1 to 3.

15. The rubber composition according to claim 4, wherein p is an integer equal to 1 or to 2.

16. The rubber composition according to claim 8, in which the molar content of the compound of formula (I) or (II) is from 0.05 mol % to 2 mol % of constituent unit of the diene elastomer.
